(19) United States
(12) Patent Application Publication
(10) Pub. No.: US 2017/0178395 A1
(43) Pub. Date: Jun. 22, 2017

(54) LIGHT FIELD RENDERING OF AN IMAGE USING VARIABLE COMPUTATIONAL COMPLEXITY

(71) Applicant: Google Inc., Mountain View, CA (US)

(72) Inventor: Matthew Milton Pharr, San Francisco, CA (US)

(21) Appl. No.: 15/380,948

(22) Filed: Dec. 15, 2016

Related U.S. Application Data
(60) Provisional application No. 62/268,397, filed on Dec. 16, 2015.

(51) Int. Cl. G06T 15/50; G06T 15/04; G06T 19/00; G06T 11/60

(52) U.S. Cl. CPC G06T 15/503; G06T 11/60; G06T 15/04; G06T 19/006; G06T 2207/20221

(57) ABSTRACT

Systems and methods are described include generating, using light field rendering based on a plurality of collected images, a rendered image that uses a variable computational complexity to generate a plurality of pixels of the rendered image based on a location of the pixel. The generating may include determining each pixel of a first set of pixels for the rendered image based on a blending, using a first blending technique, of one or more pixels of a first resolution mipmap image for each of the plurality of collected images, and determining each pixel of a second set of pixels for the rendered image based on a blending, using a second blending technique, of one or more pixels of a second resolution mipmap image for each of the plurality of collected images, wherein the second resolution mipmap images are lower resolution than the first resolution mipmap images.

### CROSS-REFERENCE TO RELATED APPLICATION

This application is a Nonprovisional of, and claims priority to, U.S. Patent Application No. 62/268,397, filed on Dec. 16, 2015, entitled “LIGHT FIELD RENDERING OF AN IMAGE USING VARIABLE COMPUTATIONAL COMPLEXITY”, which is incorporated by reference herein in its entirety.

### TECHNICAL FIELD

This description generally relates to light field rendering of an image. In particular, the description relates to light field rendering of an image using variable computational complexity.

### BACKGROUND

A light field may be described as the radiance at a point in a given direction. Thus, for example, in a representation of the light field radiance is a function of position and direction in regions of space free of occluders. In free space, the light field is a 4D function. Multiple images may be collected as part of a 4D light field.

### SUMMARY

According to an example implementation, a computer-implemented method includes collecting a plurality of images from multiple cameras; generating, using light field rendering based on a plurality of collected images, a rendered image for output to a display, the display including a center portion of pixels proximate to a center of the display and an outer portion of pixels that are outside of the center portion of pixels, the generating including; determining the center portion of pixels for the rendered image based on a blending of one or more pixels of a plurality of the collected images using a first computational complexity; and determining the outer portion of pixels for the rendered image based on a blending of one or more pixels of a plurality of the collected images using a second computational complexity that is lower than the first computational complexity; and displaying the rendered image on the display.

According to an example implementation, an apparatus includes a memory configured to store a plurality of images collected from multiple cameras; a light field rendering module configured to: receive the plurality of collected images; generate, using light field rendering based on a plurality of collected images, a rendered image for output to a display, the display including a center portion of pixels proximate to a center of the display and an outer portion of pixels that are outside of the center portion of pixels, including; determine the center portion of pixels for the rendered image based on a blending of one or more pixels of a plurality of the collected images using a first computational complexity; and determine the outer portion of pixels for the rendered image based on a blending of one or more pixels of a plurality of the collected images using a second computational complexity that is lower than the first computational complexity; and a display configured to display the rendered image.

According to an example implementation, an apparatus includes at least one processor and at least one memory including computer instructions, when executed by the at least one processor, cause the apparatus to: collect a plurality of images from multiple cameras; generate, using light field rendering based on a plurality of collected images, a rendered image for output to a display, the display including a center portion of pixels proximate to a center of the display and an outer portion of pixels that are outside of the center portion of pixels, the generating including; determine the center portion of pixels for the rendered image based on a blending of one or more pixels of a plurality of the collected images using a first computational complexity; and determine the outer portion of pixels for the rendered image based on a blending of one or more pixels of a plurality of the collected images using a second computational complexity that is lower than the first computational complexity; and display the rendered image on the display.

According to an example implementation, a computer-implemented method is provided to use light field rendering to generate an image based on a plurality of images and using a variable computational complexity, the method including: collecting a plurality of images from multiple cameras; prefiltering each of the plurality of collected images to generate, for each of the plurality of the collected images, a plurality of progressively lower resolution mipmap images, each of the mipmap images representing a collected image; generating, using light field rendering based on a plurality of collected images, a rendered image for output to a display, the display including a center portion of pixels proximate to a center of the display and an outer portion of pixels that are outside of the center portion of pixels, the generating including: determining each pixel of the center portion of pixels for the rendered image based on a blending of one or more pixels of a first resolution mipmap image for each of the plurality of collected images; and determining each pixel of the outer portion of pixels for the rendered image based on a blending of one or more pixels of a second resolution mipmap image for each of the plurality of collected images, wherein the second resolution mipmap images are lower resolution than the first resolution mipmap images; and displaying the rendered image on a display.

According to an example implementation, an apparatus includes at least one processor and at least one memory including computer instructions, when executed by the at least one processor, cause the apparatus to: collect a plurality of images from multiple cameras; prefilter each of the plurality of collected images to generate, for each of the plurality of the collected images, a plurality of progressively lower resolution mipmap images, each of the mipmap images representing a collected image; generate, using light field rendering based on a plurality of collected images, a rendered image for output to a display, the display including a center portion of pixels proximate to a center of the display and an outer portion of pixels that are outside of the center portion of pixels, the generating including: determine each pixel of the center portion of pixels for the rendered image based on a blending of one or more pixels of a first resolution mipmap image for each of the plurality of collected images; and determine each pixel of the outer portion of pixels for the rendered image based on a blending of one or more pixels of a second resolution mipmap image for each of the plurality of collected images, wherein the second resolution mipmap images are lower resolution than the first resolution mipmap images; and display the rendered image on a display.

According to an example implementation, a computer-implemented method includes generating, using light field rendering based on a plurality of collected images, a rendered image that uses a variable computational complexity to generate a plurality of pixels of the rendered image based on a location of the pixel and displaying the rendered image on a display.

According to another example implementation, an apparatus includes at least one processor and at least one memory including computer instructions, when executed by the at least one processor, cause the apparatus to: generate, using light field rendering based on a plurality of collected images, a rendered image that uses a variable computational complexity to generate a plurality of pixels of the rendered image based on a location of the pixel, and display the rendered image on a display.

According to another example implementation, an apparatus includes at least one processor and at least one memory including computer instructions, when executed by the at least one processor, cause the apparatus to: generate, using light field rendering based on a plurality of collected images, a rendered image that uses a variable computational complexity to generate a plurality of pixels of the rendered image based on a location of the pixel, including causing the apparatus to: determine each pixel of a first set of pixels for the rendered image based on a blending, using a first blending technique, of one or more pixels of a first resolution mipmap image for each of the plurality of collected images; and determine each pixel of a second set of pixels for the rendered image based on a blending, using a second blending technique that is different from the first blending technique, of one or more pixels of a second resolution mipmap image for each of the plurality of collected images, wherein the second resolution mipmap images are a different resolution than the first resolution mipmap images; and display the rendered image on a display.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram illustrating an oriented line of a light field according to an example implementation.

FIG. 2A is a diagram illustrating a display according to an example implementation.

FIG. 2B is a diagram illustrating a display that includes a left-half and a right half according to an example implementation.

FIG. 3 is a block diagram of an example system for capturing images from multiple cameras for a light field, and then for generating, using light field rendering, a rendered image according to an example implementation.

FIG. 4 is a flow chart illustrating operations that may be used to use light field rendering to generate an image based on a plurality of images using a variable computational complexity according to an example implementation.

FIG. 5 is a flow chart illustrating a method to use light field rendering to generate an image based on a plurality of images and using variable computational complexity according to an example implementation.

FIG. 6 is a flow chart illustrating a method to generate a rendered image according to an example implementation.

FIG. 7 shows an example of a computer device and a mobile computer device that can be used to implement the techniques described here.

Like reference symbols in the various drawings indicate like elements.

### DETAILED DESCRIPTION

A light field may be described as the radiance at a point in a given direction. Thus, for example, in a representation of the light field, radiance is a function of position and direction in regions of space free of occluders. In free space, the light field is a 4D function. Multiple images/views may be collected as part of a 4D light field. A new image (or new view) may be generated from the existing set of images of the light field, e.g., by extracting and resampling a slice or 2D image from the light field. A 4D light field may include a set of parameterized lines. The space of all lines may be infinite, but only a finite subset of lines is necessary. According to an example implementation, more lines means more resolution/more detail.

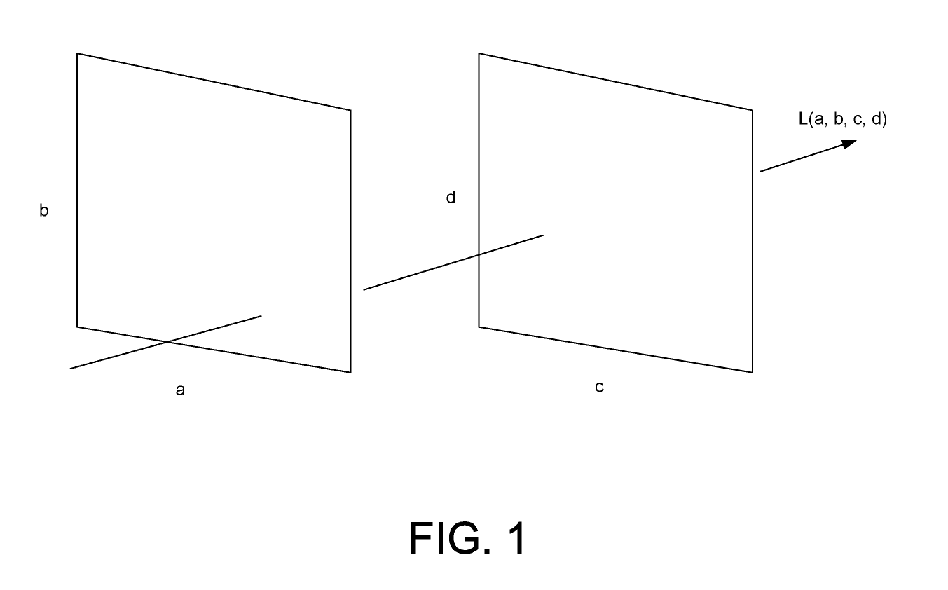

In one example implementation, lines of the 4D light field may be parameterized by their intersections with two planes in an arbitrary position. FIG. 1 is a diagram illustrating an oriented line of a light field according to an example implementation. The oriented line (or light slab) L(a, b, c, d) may be defined by connecting a point on the ab plane to a point on the cd plane. This representation may be referred to as a light slab. One of the planes, e.g., plane cd, may be placed at infinity. This may be convenient because then lines may be parameterized by a point (e.g., origin of the line) and a direction. A light field may be generated by using a plurality of cameras and generating and collecting (or storing) a plurality of images (e.g., images of an object). Thus, a light field may include a collection of images. Then, a new 2D image or view may be obtained by resampling a 2D slice of the 4D light field, which may include, for example: 1) computing (a, b, c, d) line parameters for each image ray/line and 2) resampling the radiance at those line parameters.

A significant amount of computational power and time may be required to calculate new pixels (new pixel values) and then display these new pixels (pixel values) on a display. As an illustrative example, a display may have, for example, around 2 million pixels, and the display may be refreshed at, for example, 75 times per second, e.g., screen/display refresh rate of 75 Hz. However, these example numbers are merely used as an illustrative example, and any display size (or any number of pixels per display) and any refresh rate may be used. Assuming a display refresh rate of 75 Hz, this means that, on average, a computer or computing system will need to determine updated pixels (or pixel values) and then display these pixels every 1/75^{th} of a second. In some cases, depending on the computing power, memory, etc., of the system that is performing such pixel updates and display refreshes, these display refresh operations may significantly burden many computers or computing systems.

The term pixel (or picture element) may include a picture element provided on a display, and may also include a pixel value (e.g., a multi-bit value) that may identify a luminance (or brightness) and/or color of the pixel or other pixel characteristic(s). Thus, for example, as used herein, by determining an updated pixel, this may refer to, or may include, determining an updated pixel value for the pixel.

However, at least in some cases, it may be possible to take advantage of varying degrees of resolution of the human eye to reduce the computational load and/or computational complexity for updating and/or refreshing a display. Within the human eye, the retina is a light-sensitive layer at the back of the eye that covers about 65 percent of its interior surface. Photosensitive cells called rods and cones in the retina convert incident light energy into signals that are carried to the brain by the optic nerve. In the middle of the retina is a small dimple called the fovea or fovea centralis. It is the center of the eye's sharpest vision and the location of most color perception. Thus, the eye's sharpest and most brilliantly colored vision occurs when light is focused on the tiny dimple on the retina called the fovea. This region has exclusively cones and they are smaller or more closely packed than elsewhere on the retina. Though the eye receives data from a field of about 200° (for example), the acuity over most of that range is poor. To form high resolution images, the light must fall on the fovea and that limits the acute (or high resolution) vision angle to about 15° (for example). The numbers used here to describe various characteristics of a human eye are examples, and may vary.

Therefore, according to an example implementation, light field rendering may be used to generate a rendered image based on a plurality of images (of a light field) using a variable computational complexity for one or more pixels of the rendered image. For example, light field rendering may be used to generate a rendered image based on a plurality of images (of a light field) using a variable computational complexity (or variable computational workload) for one or more pixels of the rendered image based on a location of the one or more pixels within the display (or based on a location of the one or more pixels within the rendered image). Computational complexity and/or computational workload may, for example, refer to one or more of: a complexity of techniques (e.g., complexity of various pixel blending techniques that may be used) used to determine display pixels for a rendered image; a resolution of one or more images and/or a number of images used to generate or display pixels of the rendered image; a number of computations required to generate pixels of the rendered image using light field rendering; and/or an amount of memory and/or memory transactions (e.g., reads and/or writes to memory) required to determine a pixel or pixels of the rendered image, as some examples.

According to an example implementation, a relatively high computational complexity or relatively high computational workload may be used to determine or generate pixels (pixel values) of the rendered image that are near or proximate to a center or center portion of the display or the rendered image, because such pixels are more likely to be within the eye's fovea or fovea centralis. Thus, for example, pixels within the eye's fovea or fovea centralis should preferably be or have a higher color resolution and thus, a higher computational workload or higher computational complexity may be warranted or justified for the determination or generation of such pixels of the rendered image. On the other hand a lower computational complexity or lower computational workload may be used to determine or generate pixels of the rendered image that are more than a threshold (x) away from the center or center portion of the display or of the rendered image, such as those pixels near or proximate to a periphery of the display or those pixels near a periphery of the rendered image, because such pixels are more likely to be outside of the eye's fovea. Thus, for example, a lower computational complexity and/or a lower color resolution may be used for pixels along or proximate to a periphery of a rendered image (or near or proximate to a periphery of the display) because the eye's resolution for such pixels outside of the fovea may not be able to distinguish between a high-resolution image (or high resolution colors or pixels) and a lower resolution image. Thus, to save computational workload and/or reduce computational complexity in the generation or rendering of an image and/or increase a speed to perform a display refresh, a lower computational complexity or a lower computational workload may be used in the determination or generation of such pixels outside of the eye's fovea, such as one or more pixels outside of a threshold distance from a center of the image, e.g., which may at least include pixels along or proximate to a periphery of the display or rendered image.

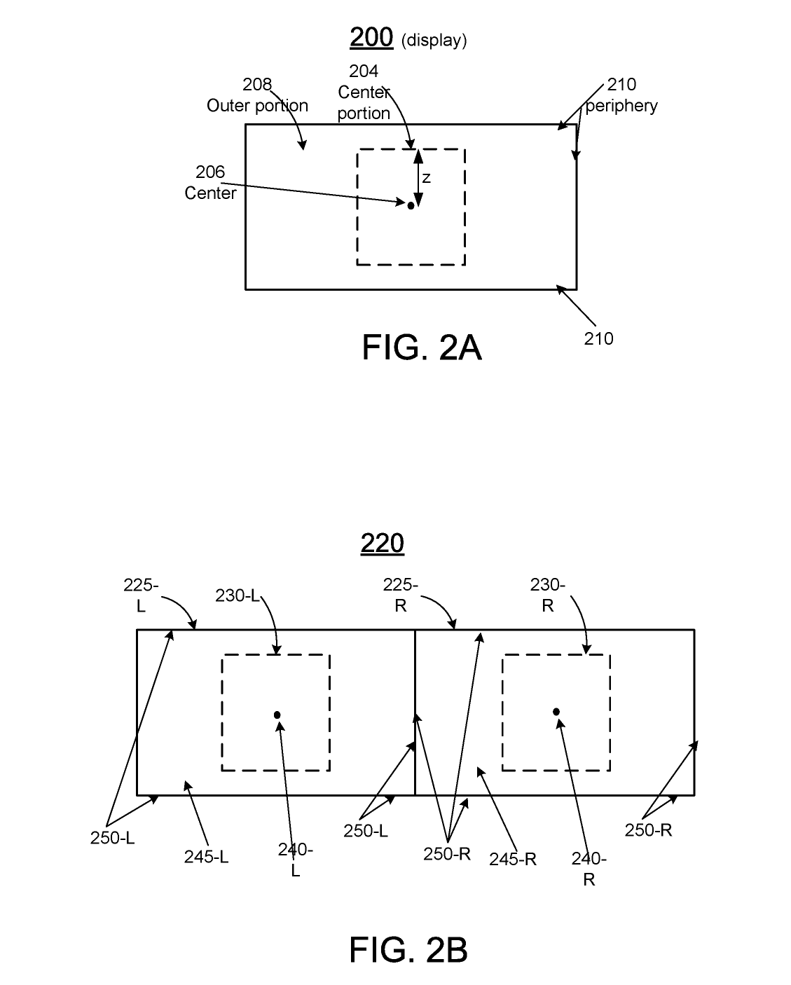

FIG. 2A is a diagram illustrating a display 200 according to an example implementation. For example, display 200 may be provided on a mobile device and/or may be provided within a head mounted display (HMD) or other device. Display 200 may be any type of display, such as a LED (light emitting diode) display, a LCD (liquid crystal display) display, or other type of display. Display 200 may include an image (not shown) rendered thereon, e.g., where the image may be generated using light field rendering. The image rendered on the display may be centered on the display and may use all of the pixels of the display 200, or may be offset on the display (e.g., shifted to one side) and/or may only use a portion of the pixels of the display 200. The explanation of the relative location of pixels for the rendered image may assume (as an illustrative example) that the rendered image is centered on the display, but the rendered image is not necessarily centered on the display.

As shown in FIG. 2A, display 200 may include a center 206 (e.g., which may also be the center of the rendered image), and a periphery 210 or an outer edge of the display 200 (which may also correspond to the periphery or outer edge of the rendered image). The pixels for the display 200 may be divided into multiple groups (or portions) based on a location of the pixels, where a different computational complexity or computational load may be used to generate the updated pixels within each group.

For example, as shown in FIG. 2A, the display 200 may include at least two groups of pixels, including 1) a center portion 204 (of pixels) that may include pixels near or proximate to a center 206 of the display 200 such as within a threshold distance (z) of the center 206 of the display 200 (e.g., within 150 pixels or within 1.5 inches of the center 206), and 2) an outer portion 208 (of pixels) that may include pixels that are outside of the center portion 204 and/or may include, for example, pixels that are greater than the threshold distance z from the center 206. In an example implementation, pixels of the outer portion 208 may include pixels near or proximate to the periphery (or outer edge) 220 of the display 200 (or near or proximate to a periphery or outer edge of the image). While only two groups of pixels (center portion 204, and outer portion 208) of display 200 are shown in FIG. 2A, the pixels of the display 200 (or the pixels of the rendered image) may be divided into any number of groups, e.g., 3, 4, 5, or more groups, where a different computational complexity may be used to generate pixels of each group, e.g., based on location of the pixel or group for the pixel. According to an example implementation, a higher level of computational complexity may be used to generate pixels within the center group 204, and a progressively lower computational complexity may be used to generate pixels of groups that are progressively farther from a center 206 (or farther from center portion 204).

Thus, according to an example implementation, this may allow greater computational resources/greater computational complexity to be used to generate pixels that are within or near the eye's fovea when viewed by the eye of a user, and may allow lesser or lower computational resources/lesser computational complexity to generate pixels that are considered to be outside the fovea when viewed by the eye of a user, for example. In this manner, at least in some cases, overall computational workload may be reduced in the use of light field rendering, while the reduction or decrease in computational complexity or computational workload may be less noticeable to the human eye, since, for example, a lower complexity computation/lower computational workload may be used to generate pixels for areas or pixels of the display 200 (or within the image) that may typically be expected to lie outside an eye's fovea.

In this example, it may be assumed, for example, that the user's eyes are looking toward or at (or at least near) the center 206 and/or center portion 204 of the display. Hence, in such case, pixels near the center 206, e.g., the center portion 204 of pixels on the display 200, are more likely to be within the fovea, for example. However, it may be possible that an eye is looking at a point on a display 200 that is not at or near the center 206. Thus, in an alternative example implementation, an eye tracker or eye tracking system such as a camera or other eye movement detector which may be provided on or mounted to a head mounted display (HMD) device, and may track the movement of the eyes and detect a point on the display 200 or the image where the eyes are looking. This may allow the HMD device or other system performing rendering to automatically adjust or select a higher computational complexity or a higher computational workload to generate those pixels of the display around or near where the eyes are looking, and to use a lower computational complexity or lower computational workload for those pixels outside of the region where the eyes are looking. This may be accomplished, for example, by shifting the center 206 and center portion 204 to be a center and center portion 204 of where the user's eyes are looking, which might be offset from a center and center portion of the display 200, for example. Other techniques may also be used. However, in general, it may be assumed that a user may be looking at a center or center portion of the display, but that techniques may be used to adjust such center/center portion if it is detected that a user's eye is not looking at the center, for example.

FIG. 2B is a diagram illustrating a display 220 that includes a left-half 225-L and a right half 225-R according to an example implementation. Thus, by way of example, the display 220 in FIG. 2B may include two separate display halves (a left half, and a right half), or may include one display that has been partitioned into two halves. According to an example implementation, the left half 225-L of the display 220 may display a left image (not shown) to a left eye, and the right half 225-R may display a right image (not shown) to a right eye, e.g., in a HMD device or other device. Similar to FIG. 2A, in FIG. 2B, the left half 225-L may include 1) a center portion 230-L (of pixels), including pixels near or proximate to a center 240-L of the left half 225-L (which may also be the center of the left image), and 2) an outer portion 245-L that includes pixels outside the center portion 230-L. The outer portion 245-L may include pixels near or proximate to a periphery 250-L or outer edge of the left half 225-L of the display 220 (which may also be the periphery or outer edge of the left image).

Similarly, in FIG. 2B, the right half 225-R of display 220 may include 1) a center portion 230-R, including pixels near or proximate to a center 240-R of the right half 225-R (which may also be the center of the right image), and 2) an outer portion 245-R that includes pixels outside the center portion 230-R. The outer portion 245-R may include pixels near or proximate to a periphery 250-R or outer edge of the right half 225-R of the display 230 (which may also be the periphery or outer edge of the right image). As described in greater detail herein, according to an example implementation, a rendered image may be generated using light field rendering, wherein a different computational complexity may be used to determine center portion pixels and the outer portion pixels, e.g., to allow greater computational resources to be used to generate pixels of the rendered image that are more likely to be within the eye's fovea (e.g., pixels in the center portion), and to use lesser computational resources to generate pixels that are likely to be outside of the fovea (e.g., pixels in the outer portion).

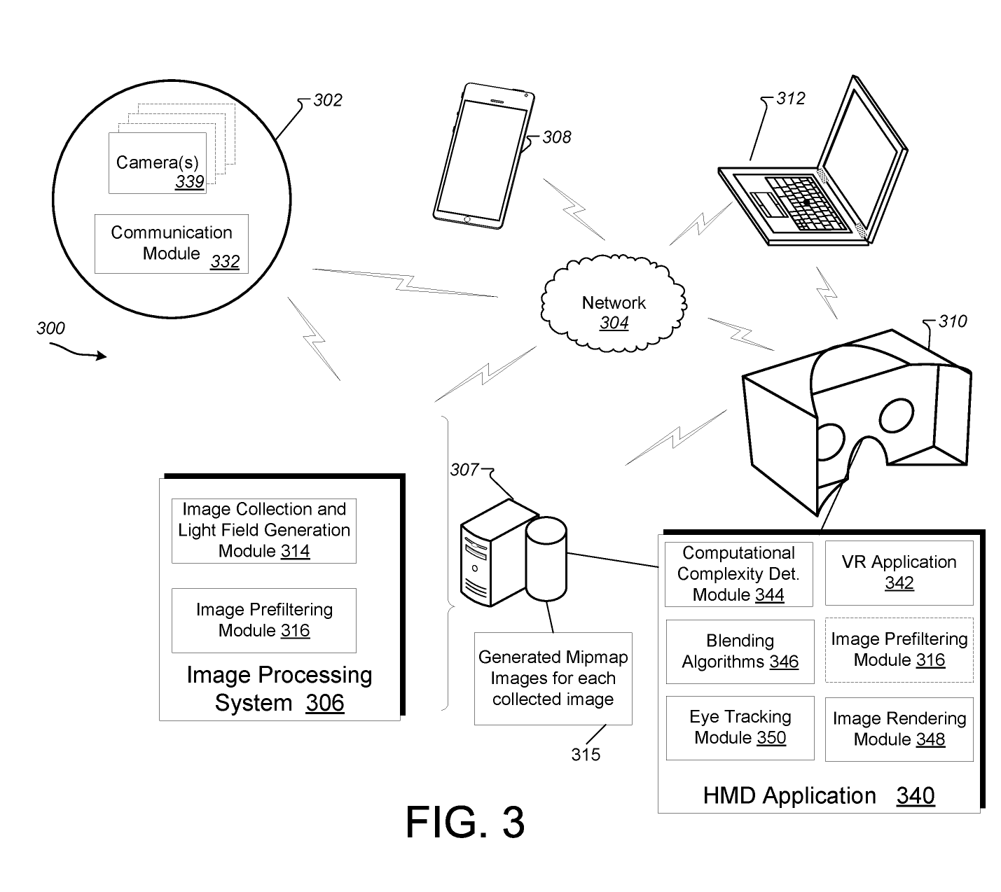

FIG. 3 is a block diagram of an example system 300 for capturing images from multiple cameras for a light field, and then for generating, using light field rendering, a rendered image according to an example implementation. System 300 may be used in a virtual reality (VR) environment, although other environments or applications may be used as well. For example, light field rendering may be used to generate accurate images of objects for VR based on multiple images of the light field, e.g., in order to provide stereo images for both left and right eyes for a head mounted display (HMD) device 310, as an example. In the example system 300, a camera rig 302, including multiple cameras 339, can capture and provide a plurality of images, directly or over a network 304, to an image processing system 306 for analysis and processing. Image processing system 306 may include a number of modules (e.g., logic or software) and may be running on a server 307 or other computer or computing device. The multiple images from the multiple camera may be a light field, for example. In some implementations of system 300, a mobile device 308 can function as the camera rig 302 to provide images throughout network 304. Alternatively, a set of cameras may each take and provide multiple images or views of an object from different locations or perspectives. In a non-limiting example, a set of 16 cameras (as an example) may each take 16 different images or views of an object, for a total of 256 different views/images for a light field. These numbers are merely an illustrative example.

Once the images are captured or collected and stored in memory, the image processing system 306 can perform a number of calculations and processes on the images and provide the originally collected images and the processed images to a head mounted display (HMD) device 310, to a mobile device 308 or to computing device 312, as examples. HMD device 310 may include a processor, memory, input/output, and a display, and a HMD application 340 that includes a number of modules (software modules or logic). In one example implementation, HMD device 310 may be hosted (or run on) mobile device 308, in which the processor, memory, display, etc. of mobile device 308 can be attached to (or may be part of) HMD device 310 and used by HMD device 310 to run HMD application 340 and perform various functions or operations associated with the modules of the HMD application 340. In another example implementation, HMD device 310 may have its own processor, memory, input/output devices, and display.

Image processing system 306 may perform analysis and/or processing of one or more of the received or collected images. Image collection and light field generation module 314 may receive or collect multiple images from each of a plurality of cameras. These original images of the light field may be stored in server 307, for example.

Image prefiltering module 316 may perform prefiltering on each of, or one or more of, the collected images from the one or more cameras 339. According to an example implementation, the image prefiltering performed by image prefiltering module 316 may include smoothing and/or pre-blurring each or one or more of the collected images to generate a lower resolution version (representation) of the collected image. To accomplish this prefiltering or pre-blurring or smoothing operation of each collected image that may result in one or more lower resolution images that represent the original collected image, a mipmap may be generated for each collected image. A mipmap may include a precalculated sequence of textures or set of mipmap images where each mipmap image is a progressively lower resolution representation of the original image. The use of mipmap images may reduce aliasing and abrupt changes and may result in a smoother image. Thus, as an illustrative example, if the original image is 16×16 (16 pixels by 16 pixels), image prefiltering module 316 may generate a set of mipmap images, where each mipmap image is a progressively lower resolution of the original 16×16 image. Thus, for example, image prefiltering module 316 may generate an 8×8 mipmap image that is a lower resolution representation of the original 16×16 image. For example, a different set (or tile) of 2×2 pixels (4 pixels total) of the original 16×16 image may be averaged to obtain a pixel of the 8×8 mipmap image. Thus, in this manner, the size of the 8×8 mipmap image is 64 bits, as compared to 256 bits of the original image. In an illustrative example, each pixel may be represented with 3 bytes, e.g., one byte for each of red, green and blue components. In a similar manner, image prefiltering module 316 may generate or determine a lower resolution 4×4 mipmap image that represents the original image, e.g., by averaging a different 4 bits of a 2×2 tile of the 8×8 mipmap image to obtain each bit of the 4×4 mipmap image. In a similar manner, a 2×2 mipmap image and a 1×1 mipmap image may be generated or determined for an image, to provide a set of progressively lower resolution mipmap images (8×8, 4×4, 2×2 and 1×1, in this example) that represent the original 16×16 image. A set of mipmap images 315 for each collected image may be stored in memory, such as on server 307, for example.

Also, referring to FIG. 3, HMD device 310 may represent a virtual reality headset, glasses, eyepiece, or other wearable device capable of displaying virtual reality content. In operation, the HMD device 310 can execute a HMD application 340 (and one or more or all of its modules), including a VR application 342 which can playback received and/or processed images to a user. In some implementations, one or more modules of the HMD application 340, such as the VR application 342, can be hosted by one or more of the devices 307, 308, 312. In one example, the HMD device 310 can provide a video playback of a scene captured by camera rig 102, or HMD device 310 may generate a new 2D image of a 4D light field based on a plurality of collected images (which may have been processed by image processing system 306).

Thus, HMD device 310 may receive a plurality of images from multiple cameras (the received images may also include processed or pre-filtered images/mipmap images, stored in server 307). The HMD device 310 may generate, using light field rendering, a rendered image based on a plurality of images (which may be a subset of all of the images of the light field and/or which may include one or more mipmap images), using a variable computational complexity to determine pixels of the rendered image, e.g., based on a location of the one or more pixels within the display or rendered image. HMD device 310 may then display the rendered image on a display of the HMD device 310.

HMD application 340 may include a number of software (or logic) modules, which will be briefly described. VR application 342 may playback or output received and/or processed images to a user such as a rendered 2D image from a light field. Computational complexity determination module 344 may determine or apply a computational complexity or computational workload to each pixel with in a display. For example, module 344 may determine, for each pixel in the display, whether the pixel is within a center portion 204 or an outer portion 208. Computational complexity determination module 344 may then determine or apply one or more computational parameters for each pixel as part of the rendering or generation of the image based on the light field, based on a location or which portion the pixel is located e.g., whether the pixel is in the center portion 204 or an outer portion 208. Thus, for example module 344 may select or apply a number of computational parameters to be used for the determination of each display pixel, such as, for example: selecting a blending algorithm or a blending technique of a plurality of blending algorithms to be used to determine one or more pixels for the rendered image, adjusting a resolution or selecting a particular resolution of each image of a plurality of images to be used to generate the rendered image, and/or adjusting or selecting a number of the collected images to be used to determine a pixel of the rendered image. Other computational parameters or features may also be selected or varied that may either increase a computational complexity for determining a pixel of a rendered image, or may decrease the computational complexity for determining a pixel of a rendered image, e.g., depending on the location of the pixel on the display.

Blending algorithms 346 may include one or more blending algorithms that may be used for blending one or more pixels from multiple images or processed images in the determination or generation of display pixels for the rendered image. These blending algorithms 346 may have different or various computational complexities. For example, a first blending algorithm or blending technique may include an averaging or a straight averaging of multiple pixels or one or more pixels among multiple images are processed images to determine a pixel of the rendered image. As another illustrative example, a second blending algorithm may include a weighted averaging of a pixel or pixels among multiple images or processed images to determine a display pixel of the rendered image. In this illustrative example, the straight averaging may be considered a lower computational complexity as compared to the weighted averaging, since for example, weighted averaging may first require determining a weight for each pixel or group of pixels to be blended or averaged whereas the straight averaging does not necessarily include any weights. As an illustrative example, larger weights may be applied to images or processed images that are closer to the user, and smaller weights may be applied to pixels of images that are farther away from the user. As a result, the weighted averaging algorithm may be considered more computationally complex than straight averaging, for example.

In some illustrative example implementations, an eye tracking module 350 may be used. Eye tracking module 350 may use, for example, a camera or other eye direction detector to track or recognize the eye movement and determine where the eye is looking. This may include for example, determining whether or not the eye is looking towards or near a center 206 or center portion 204 of the display of the HMD device 310. If, for example the user's eye is not looking towards or near a center or center portion of the display device, then the center or and/or center portion may be adjusted left or right or up or down to fall within or near where the eye is looking such that the high-resolution (high computational complexity) pixels of central center portion 204 may typically fall within the fovea, and the outer portion pixels (determined using lower computational complexity or lower computational workload) may typically be expected to fall outside the fovea. Thus, in one illustrative example implementation, eye tracking module 350 may allow (or may perform) an adjustment or movement of a center portion 204 and/or center 206 depending on where the eye is looking, e.g., so that the center 206 and/or center portion 204 may coincide or match approximately where the eye is looking, e.g., to the extent the eye is not looking towards a center or center portion of the display.

Image prefiltering module 316 may be provided within image processing system 306 and/or within HMD application 340. Thus, according to an example implementation, image prefiltering module 316 may perform prefiltering on each of, or one or more of, the collected images from the one or more cameras 339. Image prefilter module 316 may, for example, generate a set of progressively lower resolution mipmap images that represents the originally collected image. These mipmap images 315, as well as the original images, may be stored in memory, such as on server 307, for example. In one example implementation, the prefiltering performed by image prefiltering module 316 may be offloaded to image processing system 306, which may be running on server 307 or other computer. In another example implementation, the prefiltering performed by image prefiltering module 316 may be performed by the HMD device 310, such as by HMD application 340, for example. Thus, the image prefiltering module 316 may be provided in image processing system 306, HMD application 340/HMD device 310, or in both, according to example implementations.

According to an example implementation, image rendering module 348 (FIG. 3) may, for example, generate, using light field rendering based on a plurality of images, a rendered image for output to a display. As part of generating a rendered image, the image rendering module 348 may determine pixels for a center portion of pixels (e.g., center portion 204, FIG. 2A) using a first computational complexity, and may determine pixels for an outer portion of pixels (e.g., outer portion 208, FIG. 2A) using a second computational complexity. In this manner, a higher computational complexity/computational workload may be used to determine pixels that are in a center portion or within view of the fovea, and may use a lower computational complexity/computational workload to determine pixels that may be located outside the center portion or outside the view of the fovea, for example. Various techniques may be used to change or vary the computational complexity to determine display pixels at different locations, such as, for example, selecting different blending algorithms/techniques to blend pixels among multiple images, selecting different resolution images (e.g., different resolution mipmap images, where using higher resolution mipmap images is more computationally complex than using lower resolution mipmap images) that represent the original collected image for blending pixels to obtain a pixel of the rendered image, and/or selecting a different number of images to blend (e.g., more images is more computationally complex).

Also, an additional advantage of using lower-resolution mipmap images is that less bandwidth is used, including less bandwidth within a computer/computing device and potentially less network bandwidth for images, and less memory (e.g., less RAM, less storage in flash drive or hard drive) is used to store images or processed images. The image rendering module 348 may be notified, by computational complexity determination module 344, of which levels of computational complexity should be applied to determine or generate specific pixels or portions of pixels of the display. For example, computational complexity determination module 344 may notify image rendering module 348 that pixels within the center portion 204 (FIG. 2A) should be determined based on blending pixels of four first resolution (e.g., 16 bit) mipmap images using a first blending algorithm, and that pixels within the outer portion 208 (FIG. 2A) should be determined based on blending pixels of three second (e.g., 8 bit) resolution mipmap images using a second (e.g., lower computational complexity) blending algorithm for 3 images (e.g., fewer images). For example, a pixel within the center portion 204 (e.g., within view of the fovea) may (as a suggestion) be determined by weighted averaging a pixel (or multiple pixels) from four 16-bit mipmap images, with each mipmap image representing one of the originally collected/received images, and a pixel within the outer portion 208 (e.g., outside of the fovea) may (e.g., as a suggestion) be determined by straight averaging three 8-bit mipmap images. This is merely an illustrative example, and other techniques may be used.

### Example 1

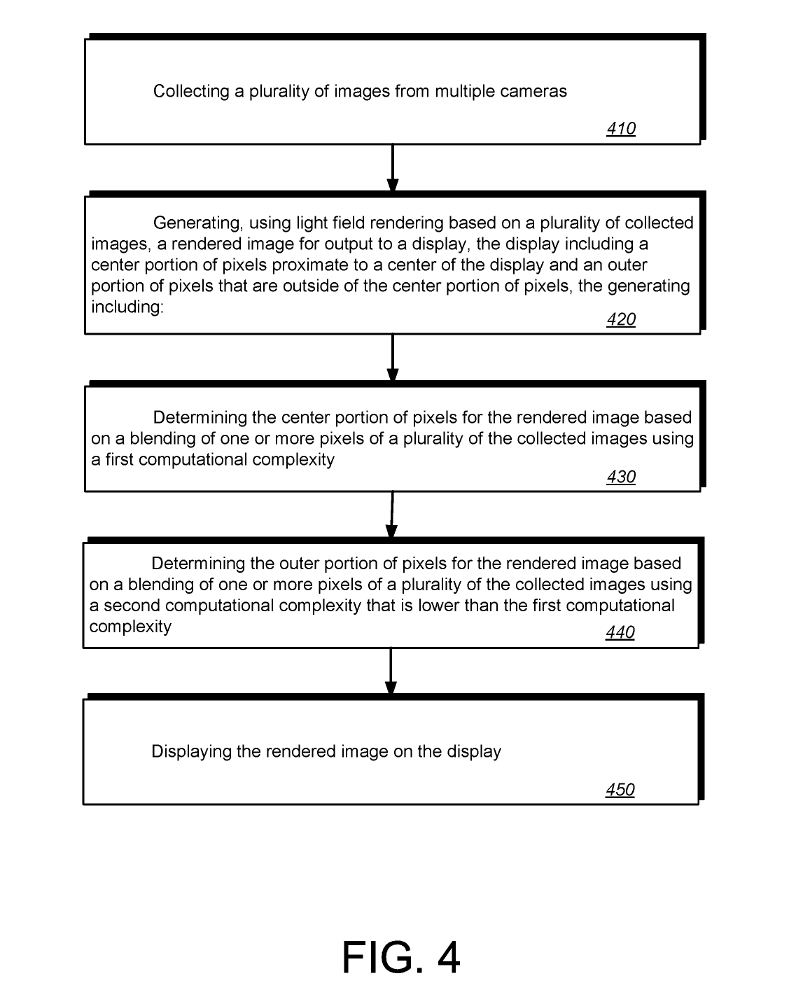

FIG. 4 is a flow chart illustrating operations that may be used to use light field rendering to generate an image based on a plurality of images using a variable computational complexity according to an example implementation. Operation 410 includes collecting a plurality of images from multiple cameras. Operation 420 includes generating, using light field rendering based on a plurality of collected images, a rendered image for output to a display, the display including a center portion of pixels proximate to a center of the display and an outer portion of pixels that are outside of the center portion of pixels, the generating including. The generating operation 420 may include operations 430 and 440. Operation 430 includes determining the center portion of pixels for the rendered image based on a blending of one or more pixels of a plurality of the collected images using a first computational complexity. Operation 440 includes determining the outer portion of pixels for the rendered image based on a blending of one or more pixels of a plurality of the collected images using a second computational complexity that is lower than the first computational complexity. And, operation 450 includes displaying the rendered image on the display.

### Example 2

According to an example implementation of the method of example 1, the first computational complexity and the second computational complexity may be determined or varied based on one or more of: selecting a blending technique of a plurality of blending techniques used to determine at least some pixels for the rendered image; adjusting a resolution of the plurality of collected images used to determine at least some pixels for the rendered image; and adjusting a number of the plurality of collected images used to determine at least some pixels for the rendered image.

### Example 3

According to an example implementation of the method of any of examples 1-2, the determining the center portion of pixels may include determining the center portion of pixels for the rendered image based on a blending of one or more pixels of a plurality of the collected images using a first blending technique, and the determining the outer portion of pixels may include determining the outer portion of pixels for the rendered image based on a blending of one or more pixels of a plurality of the collected images using a second blending technique that is less computationally complex than the first blending technique.

### Example 4

According to an example implementation of the method of any of examples 1-3, the first blending technique may include using a weighted averaging of one or more pixels among the plurality of the collected images to determine each pixel of the center portion of pixels, wherein for the weighted averaging, pixels of some of the collected images are more heavily weighted than pixels of other of the collected images, and the second blending technique may include using a straight averaging of one or more pixels among the plurality of the collected images to determine each pixel of the outer portion of pixels, wherein the weighted averaging is more computationally complex than the straight averaging.

### Example 5

According to an example implementation of the method of any of examples 1-4, the generating may include prefiltering each of the plurality of collected images to generate, for each of the plurality of the collected images, a plurality of progressively lower resolution mipmap images, each of the mipmap images representing a collected image, determining each pixel of the center portion of pixels for the rendered image based on a blending of one or more pixels of a first resolution mipmap image for each of the plurality of collected images, and determining each pixel of the outer portion of pixels for the rendered image based on a blending of one or more pixels of a second resolution mipmap image for each of the plurality of collected images, wherein the second resolution mipmap images are lower resolution than the first resolution mipmap images.

### Example 6

According to an example implementation of the method of any of examples 1-5, the method includes: using light field rendering, according to the method of claim 1, to generate each of a left image and a right image based on a plurality of images and using a variable computational complexity; and displaying the left image and the right image on the display.

### Example 7

According to an example implementation of the method of any of examples 1-6, the displaying comprises displaying the rendered image on a display of a virtual reality headset.

### Example 8

According to an example implementation, an apparatus includes a memory configured to store a plurality of images collected from multiple cameras, a light field rendering module configured to: receive the plurality of collected images, generate, using light field rendering based on a plurality of collected images, a rendered image for output to a display, the display including a center portion of pixels proximate to a center of the display and an outer portion of pixels that are outside of the center portion of pixels, including; determine the center portion of pixels for the rendered image based on a blending of one or more pixels of a plurality of the collected images using a first computational complexity; and determine the outer portion of pixels for the rendered image based on a blending of one or more pixels of a plurality of the collected images using a second computational complexity that is lower than the first computational complexity; and a display configured to display the rendered image.

### Example 9

According to an example implantation of the apparatus of example 8, the apparatus is provided as part of a head mounted display (HMD).

### Example 10

According to an example implantation of the apparatus of any of examples 8-9, the apparatus is provided as part of a virtual reality headset or a virtual reality system.

### Example 11

According to an example implementation, an apparatus includes at least one processor and at least one memory including computer instructions, when executed by the at least one processor, cause the apparatus to: collect a plurality of images from multiple cameras, generate, using light field rendering based on a plurality of collected images, a rendered image for output to a display, the display including a center portion of pixels proximate to a center of the display and an outer portion of pixels that are outside of the center portion of pixels, the generating including: determine the center portion of pixels for the rendered image based on a blending of one or more pixels of a plurality of the collected images using a first computational complexity, and determine the outer portion of pixels for the rendered image based on a blending of one or more pixels of a plurality of the collected images using a second computational complexity that is lower than the first computational complexity, and display the rendered image on the display.

### Example 12

An apparatus may include means for collecting a plurality of images from multiple cameras, means for generating, using light field rendering based on a plurality of collected images, a rendered image for output to a display, the display including a center portion of pixels proximate to a center of the display and an outer portion of pixels that are outside of the center portion of pixels, the means for generating including means for determining the center portion of pixels for the rendered image based on a blending of one or more pixels of a plurality of the collected images using a first computational complexity, and means for determining the outer portion of pixels for the rendered image based on a blending of one or more pixels of a plurality of the collected images using a second computational complexity that is lower than the first computational complexity; and means for displaying the rendered image on the display.

### Example 13

According to an example implementation of the apparatus of example 12, the first computational complexity and the second computational complexity may be determined or varied based on one or more of: means for selecting a blending technique of a plurality of blending techniques used to determine at least some pixels for the rendered image, means for adjusting a resolution of the plurality of collected images used to determine at least some pixels for the rendered image, and means for adjusting a number of the plurality of collected images used to determine at least some pixels for the rendered image.

### Example 14

According to an example implementation of the apparatus of any of examples 12-13, the means for determining the center portion of pixels may include means for determining the center portion of pixels for the rendered image based on a blending of one or more pixels of a plurality of the collected images using a first blending technique, and wherein the means for determining the outer portion of pixels may include means for determining the outer portion of pixels for the rendered image based on a blending of one or more pixels of a plurality of the collected images using a second blending technique that is less computationally complex than the first blending technique.

### Example 15

According to an example implementation of the apparatus of any of examples 12-14, the first blending technique may include using a weighted averaging of one or more pixels among the plurality of the collected images to determine each pixel of the center portion of pixels, wherein for the weighted averaging, pixels of some of the collected images are more heavily weighted than pixels of other of the collected images, and wherein the second blending technique may include using a straight averaging of one or more pixels among the plurality of the collected images to determine each pixel of the outer portion of pixels, wherein the weighted averaging is more computationally complex than the straight averaging.

### Example 16

According to an example implementation of the apparatus of any of examples 12-15, the means for generating may include means for prefiltering each of the plurality of collected images to generate, for each of the plurality of the collected images, a plurality of progressively lower resolution mipmap images, each of the mipmap images representing a collected image, means for determining each pixel of the center portion of pixels for the rendered image based on a blending of one or more pixels of a first resolution mipmap image for each of the plurality of collected images, and means for determining each pixel of the outer portion of pixels for the rendered image based on a blending of one or more pixels of a second resolution mipmap image for each of the plurality of collected images, wherein the second resolution mipmap images are lower resolution than the first resolution mipmap images.

### Example 17

According to an example implementation of the apparatus of any of examples 12-16, the apparatus including means for using light field rendering, according to the method of claim 1, to generate each of a left image and a right image based on a plurality of images and using a variable computational complexity, and means for displaying the left image and the right image on the display.

### Example 18

According to an example implementation of the apparatus of any of examples 12-17, the means for displaying may include means for displaying the rendered image on a display of a virtual reality headset.

### Example 19

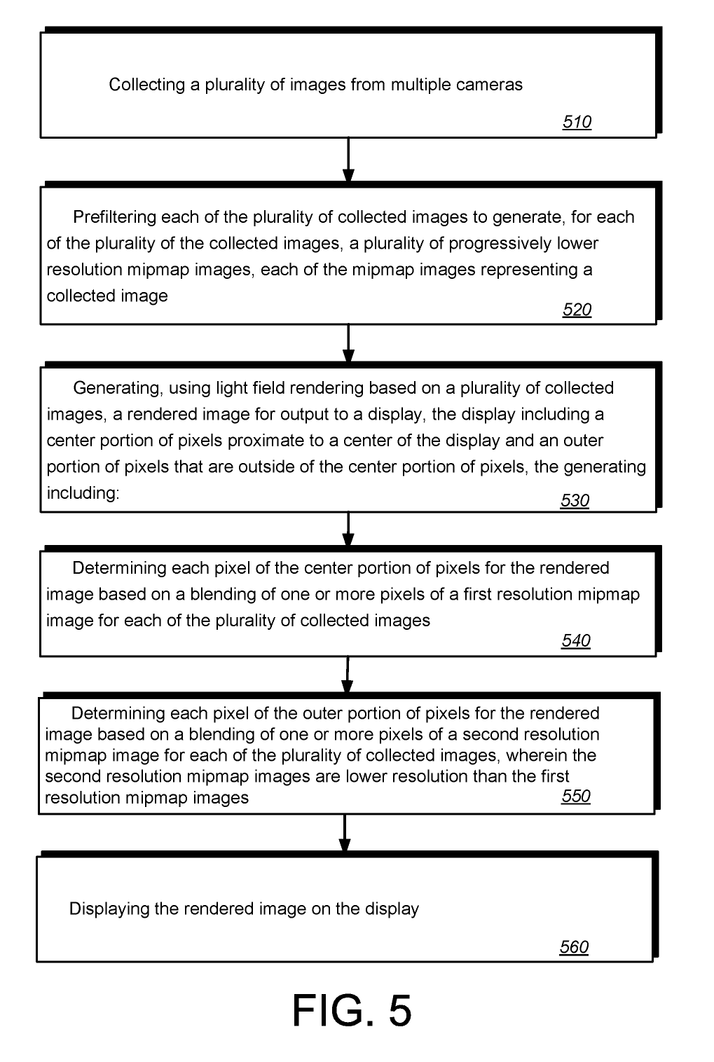

FIG. 5 is a flow chart illustrating a method to use light field rendering to generate an image based on a plurality of images and using variable computational complexity according to an example implementation. Operation 510 includes collecting a plurality of images from multiple cameras. Operation 520 includes prefiltering each of the plurality of collected images to generate, for each of the plurality of the collected images, a plurality of progressively lower resolution mipmap images, each of the mipmap images representing a collected image. Operation 530 includes generating, using light field rendering based on a plurality of collected images, a rendered image for output to a display, the display including a center portion of pixels proximate to a center of the display and an outer portion of pixels that are outside of the center portion of pixels. The generating operation of 530 includes operations 540 and 550. Operation 540 includes determining each pixel of the center portion of pixels for the rendered image based on a blending of one or more pixels of a first resolution mipmap image for each of the plurality of collected images. Operation 550 includes determining each pixel of the outer portion of pixels for the rendered image based on a blending of one or more pixels of a second resolution mipmap image for each of the plurality of collected images, wherein the second resolution mipmap images are lower resolution than the first resolution mipmap images. Operation 560 includes displaying the rendered image on a display.

### Example 20

According to an example implementation of the method of example 19, the determining the center portion of pixels may include determining the center portion of pixels for the rendered image based on a blending, using a first blending technique, of one or more pixels of a first resolution mipmap image for each of a plurality of collected images, and the determining the outer portion of pixels may include determining the outer portion of pixels for the rendered image based on a blending, using a second blending technique, of one or more pixels of a second resolution mipmap image for each of a plurality of collected images, wherein the first blending technique is computationally more expensive than the second blending technique.

### Example 21

According to an example implementation, an apparatus includes at least one processor and at least one memory including computer instructions, when executed by the at least one processor, cause the apparatus to: collect a plurality of images from multiple cameras, prefilter each of the plurality of collected images to generate, for each of the plurality of the collected images, a plurality of progressively lower resolution mipmap images, each of the mipmap images representing a collected image, generate, using light field rendering based on a plurality of collected images, a rendered image for output to a display, the display including a center portion of pixels proximate to a center of the display and an outer portion of pixels that are outside of the center portion of pixels, the generating including: determine each pixel of the center portion of pixels for the rendered image based on a blending of one or more pixels of a first resolution mipmap image for each of the plurality of collected images, and determine each pixel of the outer portion of pixels for the rendered image based on a blending of one or more pixels of a second resolution mipmap image for each of the plurality of collected images, wherein the second resolution mipmap images are lower resolution than the first resolution mipmap images, and display the rendered image on a display.

### Example 22

According to an example implementation, an apparatus includes means for collecting a plurality of images from multiple cameras, means for prefiltering each of the plurality of collected images to generate, for each of the plurality of the collected images, a plurality of progressively lower resolution mipmap images, each of the mipmap images representing a collected image, means for generating, using light field rendering based on a plurality of collected images, a rendered image for output to a display, the display including a center portion of pixels proximate to a center of the display and an outer portion of pixels that are outside of the center portion of pixels, the means for generating including means for determining each pixel of the center portion of pixels for the rendered image based on a blending of one or more pixels of a first resolution mipmap image for each of the plurality of collected images, and means for determining each pixel of the outer portion of pixels for the rendered image based on a blending of one or more pixels of a second resolution mipmap image for each of the plurality of collected images, wherein the second resolution mipmap images are lower resolution than the first resolution mipmap images, and means for displaying the rendered image on a display.

### Example 23

According to an example implementation of the apparatus of example 22, the means for determining the center portion of pixels may include means for determining the center portion of pixels for the rendered image based on a blending, using a first blending technique, of one or more pixels of a first resolution mipmap image for each of a plurality of collected images, and wherein the means for determining the outer portion of pixels may include means for determining the outer portion of pixels for the rendered image based on a blending, using a second blending technique, of one or more pixels of a second resolution mipmap image for each of a plurality of collected images, wherein the first blending technique is computationally more expensive than the second blending technique.

### Example 24

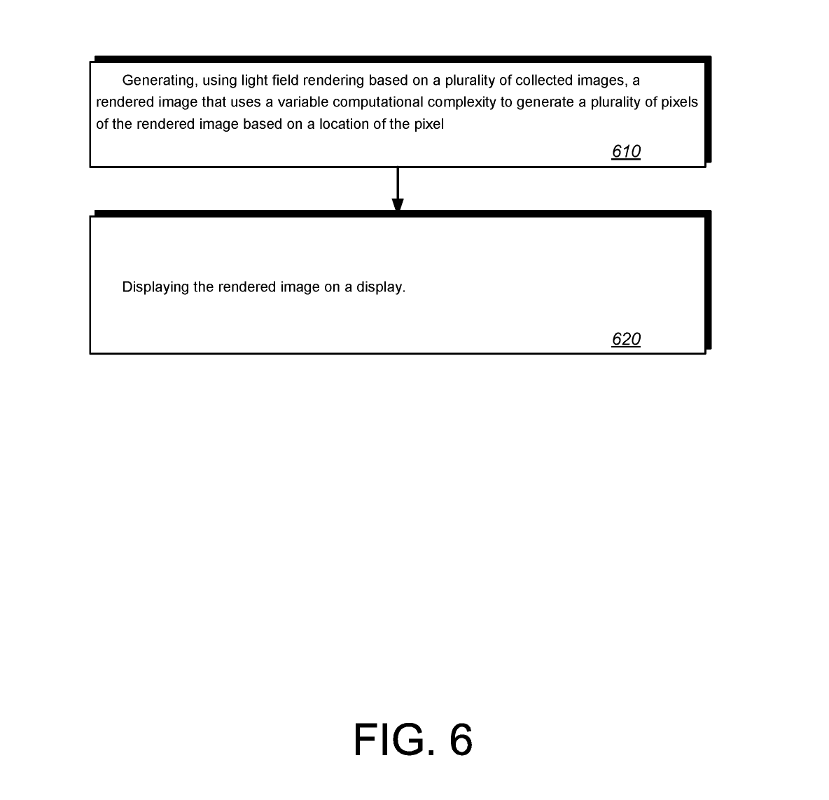

FIG. 6 is a flow chart illustrating a method to generate a rendered image according to an example implementation. Operation 610 includes generating, using light field rendering based on a plurality of collected images, a rendered image that uses a variable computational complexity to generate a plurality of pixels of the rendered image based on a location of the pixel. And, operation 620 includes displaying the rendered image on a display.

### Example 25

According to an example implementation of the method of example 24, the generating may determining a first set of pixels of the rendered image based on a blending of one or more pixels of a plurality of the collected images using a first blending technique; and determining a second set of pixels for the rendered image based on a blending of one or more pixels of a plurality of the collected images using a second blending technique that is less computationally complex than the first blending technique.

### Example 26

According to an example implementation of the method of any of examples 24-25, the first set of pixels may include a center portion of pixels proximate to a center of the display, and wherein the second set of pixels may include an outer portion of pixels that are outside of the center portion of pixels.

### Example 27

According to an example implementation of the method of any of examples 24-26, the first blending technique may include performing a weighted averaging of one or more pixels among the plurality of the collected images to determine each pixel of the first set of pixels, wherein for the weighted averaging, pixels of some of the collected images are more heavily weighted than pixels of other of the collected images; and wherein the second blending technique may include performing a straight averaging of one or more pixels among the plurality of the collected images to determine each pixel of the second set of pixels, wherein the weighted averaging is more computationally complex than the straight averaging.

### Example 28

According to an example implementation of the method of any of examples 24-27, the rendered image may include a first set of pixels and a second set of pixels, wherein the generating may include: prefiltering each of the plurality of collected images to generate, for each of the plurality of the collected images, a plurality of progressively lower resolution mipmap images, each of the mipmap images representing a collected image; determining each pixel of the first set of pixels for the rendered image based on a blending of one or more pixels of a first resolution mipmap image for each of the plurality of collected images; and determining each pixel of the second set of pixels for the rendered image based on a blending of one or more pixels of a second resolution mipmap image for each of the plurality of collected images, wherein the second resolution mipmap images are lower resolution than the first resolution mipmap images.

### Example 29

According to an example implementation of the method of any of examples 24-28, the rendered image may include a first set of pixels and a second set of pixels, wherein the generating may include: determining each pixel of the first set of pixels for the rendered image based on a blending, using a first blending technique, of one or more pixels of a first resolution mipmap image for each of the plurality of collected images; and determining each pixel of the second set of pixels for the rendered image based on a blending, using a second blending technique that is different than the first blending technique, of one or more pixels of a second resolution mipmap image for each of the plurality of collected images, wherein the second resolution mipmap images are lower resolution than the first resolution mipmap images.

### Example 30

According to an example implementation, an apparatus includes at least one processor and at least one memory including computer instructions, when executed by the at least one processor, cause the apparatus to: generate, using light field rendering based on a plurality of collected images, a rendered image that uses a variable computational complexity to generate a plurality of pixels of the rendered image based on a location of the pixel; and display the rendered image on a display.

### Example 31

According to an example implementation of the apparatus of example 30, further causing the apparatus to: determine a first set of pixels of the rendered image based on a blending of one or more pixels of a plurality of the collected images using a first blending technique, and determine a second set of pixels for the rendered image based on a blending of one or more pixels of a plurality of the collected images using a second blending technique that is less computationally complex than the first blending technique.

### Example 32

According to an example implementation of the apparatus of any of examples 30-31, the first set of pixels include a center portion of pixels proximate to a center of the display, and wherein the second set of pixels comprise an outer portion of pixels that are outside of the center portion of pixels.

### Example 33

According to an example implementation of the apparatus of any of examples 30-32, causing the apparatus to generate includes causing the apparatus to generate, using light field rendering based on a plurality of collected images, a rendered left image and a rendered right image that each uses a variable computational complexity to generate a plurality of pixels of the rendered left image and the rendered right image based on a location of the pixel, and wherein causing the apparatus to display includes causing the apparatus to display the rendered left image and the rendered right image on a display.

### Example 34

According to an example implementation of the apparatus of any of examples 30-33, causing the apparatus to display includes causing the apparatus to display the rendered image on a display of a virtual reality headset.

### Example 35

According to an example implementation, an apparatus includes at least one processor and at least one memory including computer instructions, when executed by the at least one processor, cause the apparatus to: generate, using light field rendering based on a plurality of collected images, a rendered image that uses a variable computational complexity to generate a plurality of pixels of the rendered image based on a location of the pixel, including causing the apparatus to: determine each pixel of a first set of pixels for the rendered image based on a blending, using a first blending technique, of one or more pixels of a first resolution mipmap image for each of the plurality of collected images; and determine each pixel of a second set of pixels for the rendered image based on a blending, using a second blending technique that is different from the first blending technique, of one or more pixels of a second resolution mipmap image for each of the plurality of collected images, wherein the second resolution mipmap images are a different resolution than the first resolution mipmap images; and display the rendered image on a display.

### Example 36

According to an example implementation, an apparatus includes means for generating, using light field rendering based on a plurality of collected images, a rendered image that uses a variable computational complexity to generate a plurality of pixels of the rendered image based on a location of the pixel, and means for displaying the rendered image on a display.

### Example 37

According to an example implementation of the apparatus of example 36, the means for generating may include means for determining a first set of pixels of the rendered image based on a blending of one or more pixels of a plurality of the collected images using a first blending technique, and means for determining a second set of pixels for the rendered image based on a blending of one or more pixels of a plurality of the collected images using a second blending technique that is less computationally complex than the first blending technique.

### Example 38

According to an example implementation of the apparatus of any of examples 36-37, the first set of pixels may include a center portion of pixels proximate to a center of the display, and wherein the second set of pixels may include an outer portion of pixels that are outside of the center portion of pixels.

### Example 39

According to an example implementation of the apparatus of any of examples 36-38, the first blending technique may include performing a weighted averaging of one or more pixels among the plurality of the collected images to determine each pixel of the first set of pixels, wherein for the weighted averaging, pixels of some of the collected images are more heavily weighted than pixels of other of the collected images; and wherein the second blending technique may include performing a straight averaging of one or more pixels among the plurality of the collected images to determine each pixel of the second set of pixels, wherein the weighted averaging is more computationally complex than the straight averaging.

### Example 40

According to an example implementation of the apparatus of any of examples 36-39, the rendered image may include a first set of pixels and a second set of pixels, wherein the means for generating may include: means for prefiltering each of the plurality of collected images to generate, for each of the plurality of the collected images, a plurality of progressively lower resolution mipmap images, each of the mipmap images representing a collected image; determining each pixel of the first set of pixels for the rendered image based on a blending of one or more pixels of a first resolution mipmap image for each of the plurality of collected images, and means for determining each pixel of the second set of pixels for the rendered image based on a blending of one or more pixels of a second resolution mipmap image for each of the plurality of collected images, wherein the second resolution mipmap images are lower resolution than the first resolution mipmap images.

### Example 41

According to an example implementation of the apparatus of any of examples 36-40, the rendered image may include a first set of pixels and a second set of pixels, wherein the means for generating may include: means for determining each pixel of the first set of pixels for the rendered image based on a blending, using a first blending technique, of one or more pixels of a first resolution mipmap image for each of the plurality of collected images; and means for determining each pixel of the second set of pixels for the rendered image based on a blending, using a second blending technique that is different than the first blending technique, of one or more pixels of a second resolution mipmap image for each of the plurality of collected images, wherein the second resolution mipmap images are lower resolution than the first resolution mipmap images.

According to an example implementation, an image to be rendered may include a first portion of pixels and a second portion of pixels. According to an example implementation, the first portion, thereby, may be a center portion, where the term center portion may correspond to a set of pixels, which correspond to the pixels of the rendered image, which are more likely to fall onto the fovea of a human eye viewing the image, while the second portion of pixels (which may be referred to as “non-center portion” or “outer portion”) may correspond to a set of pixels or an area of the rendered image, which is less likely to fall onto the fovea of a human eye viewing the rendered image. The distinction between the first and second sets of pixels or the first and second areas may, for example, be made by defining a first area of the image and a second area of the image, with the second area of the image surrounding the first area of the image such that the first area of the image lies fully or at least partly inside the second area of the image. The first and second areas may thereby be arbitrarily shaped according to a predefined pattern, while the first area lies inside the second area and is fully or at least partly surrounded by the second area. Since the fovea typically corresponds to the central area of the field of view of a user, such a separation into first area (a center area) and second area (a non-center area) results in that the pixels the first area are more likely to fall onto the fovea than the pixels of the second area. In other words, the first area is chosen such that its pixels more likely correspond to the fovea than the pixels of the second area.

One possibility, or illustrative example, to achieve this is to define a first area as corresponding to a center part (or center area or center portion) of the image and a second area corresponding to the remaining part of the image. Assuming that a user is likely to focus on the center part of the image, such a separation likely achieves its goal to let the first area fall onto the fovea. However, other separations into first and second areas are also possible. For example the first area may be an area of a predetermined shape (a square, a circle or any other shape), the center of which is chosen to coincide with the point of regard of a user as determined by an eyetracker. Since an eyetracker determines the center of the field of view as a point of regard focused by the user, choosing the first area to lie around the point of regard has the effect that the first area of the rendered image is more likely to fall onto the fovea than the second area when the image is viewed by a user. Once the separation into a first area and a second area has been made, according to an example implementation, the first and second portions of the image may be determined or rendered using methods employing different computational complexity. According to an exemplary implementation thereby the pixels of a first area corresponding to the fovea are determined or rendered using a higher computational complexity and the pixels of the second area are rendered using a lower computational complexity. According to this example implementation, this leads to a higher image quality in the first area than in the second area. However, since the pixels of the second area most likely do not fall onto the fovea, this does not reduce the perceived image quality while reducing the overall computational complexity, thereby saving computational resources and improving rendering speed. In a further exemplary embodiment, the determining or rendering of the pixels of the second portion may be performed employing a smaller resolution than the determining or rendering of the pixels of the first portion. The determining of the pixels of the second portion may thereby require less computational complexity (and thus less computational resources) than the determining o rendering of the pixels of the first portion.

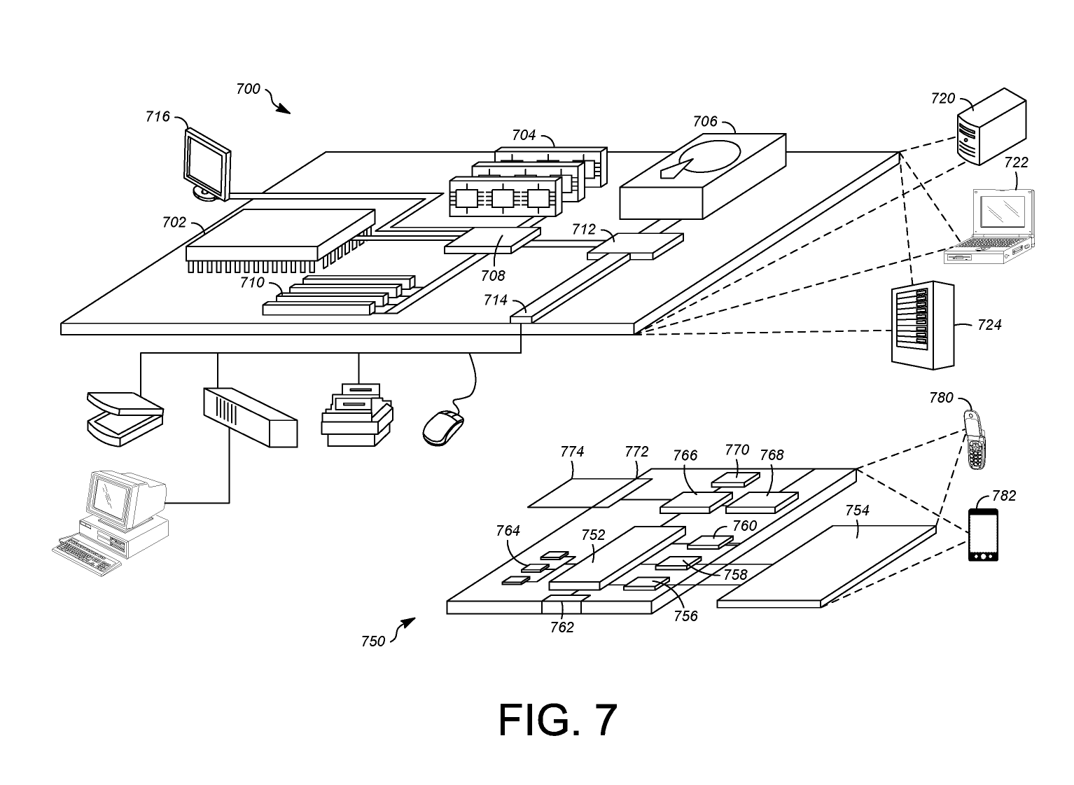

FIG. 7 shows an example of a generic computer device 700 and a generic mobile computer device 750, which may be used with the techniques described here. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor sy stem).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smart phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented method to use light field rendering to generate an image based on a plurality of images and using a variable computational complexity, the method comprising:
collecting a plurality of images from multiple cameras;
generating, using light field rendering based on a plurality of collected images, a rendered image for output to a display, the display including a center portion of pixels proximate to a center of the display and an outer portion of pixels that are outside of the center portion of pixels, the generating including;
determining the center portion of pixels for the rendered image based on a blending of one or more pixels of a plurality of the collected images using a first computational complexity; and
determining the outer portion of pixels for the rendered image based on a blending of one or more pixels of a plurality of the collected images using a second computational complexity that is lower than the first computational complexity; and
displaying the rendered image on the display.

2. The computer-implemented method of claim 1 wherein the first computational complexity and the second computational complexity may be determined or varied based on one or more of:
selecting a blending technique of a plurality of blending techniques used to determine at least some pixels for the rendered image; and
adjusting a resolution of the plurality of collected images used to determine at least some pixels for the rendered image; and
adjusting a number of the plurality of collected images used to determine at least some pixels for the rendered image.

3. The computer-implemented method of claim 1:
wherein the determining the center portion of pixels comprises determining the center portion of pixels for the rendered image based on a blending of one or more pixels of a plurality of the collected images using a first blending technique; and
wherein the determining the outer portion of pixels comprises determining the outer portion of pixels for the rendered image based on a blending of one or more pixels of a plurality of the collected images using a second blending technique that is less computationally complex than the first blending technique.

4. The computer-implemented method of claim 3:
wherein the first blending technique comprises using a weighted averaging of one or more pixels among the plurality of the collected images to determine each pixel of the center portion of pixels, wherein for the weighted averaging, pixels of some of the collected images are more heavily weighted than pixels of other of the collected images; and
wherein the second blending technique comprises using a straight averaging of one or more pixels among the plurality of the collected images to determine each pixel of the outer portion of pixels, wherein the weighted averaging is more computationally complex than the straight averaging.

5. The computer-implemented method of claim 1 wherein the generating comprises:
prefiltering each of the plurality of collected images to generate, for each of the plurality of the collected images, a plurality of progressively lower resolution mipmap images, each of the mipmap images representing a collected image;
determining each pixel of the center portion of pixels for the rendered image based on a blending of one or more pixels of a first resolution mipmap image for each of the plurality of collected images; and
determining each pixel of the outer portion of pixels for the rendered image based on a blending of one or more pixels of a second resolution mipmap image for each of the plurality of collected images, wherein the second resolution mipmap images are lower resolution than the first resolution mipmap images.

6. The computer-implemented method of claim 1 wherein the method comprises:
using light field rendering, according to the method of claim 1, to generate each of a left image and a right image based on a plurality of images and using a variable computational complexity; and
displaying the left image and the right image on the display.

7. The computer-implemented method of claim 1 wherein the displaying comprises displaying the rendered image on a display of a virtual reality headset.

8. An apparatus comprising
a memory configured to store a plurality of images collected from multiple cameras;
a light field rendering module configured to:
receive the plurality of collected images;
generate, using light field rendering based on a plurality of collected images, a rendered image for output to a display, the display including a center portion of pixels proximate to a center of the display and an outer portion of pixels that are outside of the center portion of pixels, including;
determine the center portion of pixels for the rendered image based on a blending of one or more pixels of a plurality of the collected images using a first computational complexity; and
determine the outer portion of pixels for the rendered image based on a blending of one or more pixels of a plurality of the collected images using a second computational complexity that is lower than the first computational complexity; and
a display configured to display the rendered image.

9. The apparatus of claim 8 wherein the apparatus is provided as part of a head mounted display (HMD).

10. The apparatus of claim 8 wherein the apparatus is provided as part of a virtual reality headset or a virtual reality system.

11. A computer-implemented method to use light field rendering to generate an image based on a plurality of images and using a variable computational complexity, the method comprising:
collecting a plurality of images from multiple cameras;
prefiltering each of the plurality of collected images to generate, for each of the plurality of the collected images, a plurality of progressively lower resolution mipmap images, each of the mipmap images representing a collected image;
generating, using light field rendering based on a plurality of collected images, a rendered image for output to a display, the display including a center portion of pixels proximate to a center of the display and an outer portion of pixels that are outside of the center portion of pixels, the generating including:
determining each pixel of the center portion of pixels for the rendered image based on a blending of one or more pixels of a first resolution mipmap image for each of the plurality of collected images; and
determining each pixel of the outer portion of pixels for the rendered image based on a blending of one or more pixels of a second resolution mipmap image for each of the plurality of collected images, wherein the second resolution mipmap images are lower resolution than the first resolution mipmap images; and
displaying the rendered image on a display.

12. The method of claim 11 wherein:
wherein the determining the center portion of pixels comprises determining the center portion of pixels for the rendered image based on a blending, using a first blending technique, of one or more pixels of a first resolution mipmap image for each of a plurality of collected images; and
wherein the determining the outer portion of pixels comprises determining the outer portion of pixels for the rendered image based on a blending, using a second blending technique, of one or more pixels of a second resolution mipmap image for each of a plurality of collected images, wherein the first blending technique is computationally more expensive than the second blending technique.

13. A computer-implemented method comprising:
generating, using light field rendering based on a plurality of collected images, a rendered image that uses a variable computational complexity to generate a plurality of pixels of the rendered image based on a location of the pixel; and
displaying the rendered image on a display.

14. The computer-implemented method of claim 13 wherein the generating comprises:
determining a first set of pixels of the rendered image based on a blending of one or more pixels of a plurality of the collected images using a first blending technique; and
determining a second set of pixels for the rendered image based on a blending of one or more pixels of a plurality of the collected images using a second blending technique that is less computationally complex than the first blending technique.

15. The computer-implemented method of claim 14 wherein the first set of pixels comprise a center portion of pixels proximate to a center of the display, and wherein the second set of pixels comprise an outer portion of pixels that are outside of the center portion of pixels.

16. The computer-implemented method of claim 14:
wherein the first blending technique comprises performing a weighted averaging of one or more pixels among the plurality of the collected images to determine each pixel of the first set of pixels, wherein for the weighted averaging, pixels of some of the collected images are more heavily weighted than pixels of other of the collected images; and
wherein the second blending technique comprises performing a straight averaging of one or more pixels among the plurality of the collected images to determine each pixel of the second set of pixels, wherein the weighted averaging is more computationally complex than the straight averaging.

17. The computer-implemented method of claim 14, wherein the rendered image comprises a first set of pixels and a second set of pixels, wherein the generating comprises:
prefiltering each of the plurality of collected images to generate, for each of the plurality of the collected images, a plurality of progressively lower resolution mipmap images, each of the mipmap images representing a collected image;
determining each pixel of the first set of pixels for the rendered image based on a blending of one or more pixels of a first resolution mipmap image for each of the plurality of collected images; and
determining each pixel of the second set of pixels for the rendered image based on a blending of one or more pixels of a second resolution mipmap image for each of the plurality of collected images, wherein the second resolution mipmap images are lower resolution than the first resolution mipmap images.

18. The computer-implemented method of claim 14, wherein the rendered image comprises a first set of pixels and a second set of pixels, wherein the generating comprises:
determining each pixel of the first set of pixels for the rendered image based on a blending, using a first blending technique, of one or more pixels of a first resolution mipmap image for each of the plurality of collected images; and
determining each pixel of the second set of pixels for the rendered image based on a blending, using a second blending technique that is different than the first blending technique, of one or more pixels of a second resolution mipmap image for each of the plurality of collected images, wherein the second resolution mipmap images are lower resolution than the first resolution mipmap images.

19. The computer-implemented method of claim 14, wherein:
the generating comprises generating, using light field rendering based on a plurality of collected images, a rendered left image and a rendered right image that each uses a variable computational complexity to generate a plurality of pixels of the rendered left image and the rendered right image based on a location of the pixel; and
wherein the displaying comprises displaying the rendered left image and the rendered right image on a display.

20. The computer-implemented method of claim 13 wherein the displaying comprises displaying the rendered image on a display of a virtual reality headset.
